(19) United States
(12) Patent Application Publication
(10) Pub. No.: US 2018/0160220 A1
(43) Pub. Date: Jun. 7, 2018

(54) ACOUSTICAL DIFFUSION MANIFOLD

(71) Applicant: ACOUSTIC 3D HOLDINGS LTD, Brisbane, QLD (AU)

(72) Inventor: Joseph HAYES, Wyberba, QLD (AU)

(73) Assignee: ACOUSTIC 3D HOLDINGS LTD, Brisbane, QLD (AU)

(21) Appl. No.: 15/571,707

(22) PCT Filed: May 5, 2016
(86) PCT No.: PCT/AU2016/000154

§ 371 Date: Nov. 3, 2017

(30) Foreign Application Priority Data
May 7, 2015 (AU) 2015901657

(51) Int. Cl. H04R 1/28; G10K 11/22; G10K 11/00

(52) U.S. Cl. CPC H04R 1/2857; G10K 11/002; G10K 11/22

(57) ABSTRACT

An acoustical diffusion manifold transducer system which includes: a surface having a plurality (N or N2), where N is an odd prime number) of acoustical channels arranged in an N jc 1 or N×N matrix; and each acoustic channel driven by a loudspeaker driver and each channel length governed by the relationship Ti.j=[(i2+j2) rem N]* unit delay. Where T is delay between channels having sequential values in the number sequence and N is a prime number. The channels are arranged to end in an outlet device so that sound waves from the speaker driver arrive in an ordered sequence, the outlet of each channel has the same area. The channels are pathways for sound waves generated by the loudspeaker driver and are preferably enclosed tubes of any suitable cross section.

The present invention relates to an acoustical arrangement, and in particular, to an acoustical arrangement that provides a means of generating diffuse waves within a fluid space. In particular this invention is directed to laud speaker arrangements adapted to generate diffuse waves.

### BACK GROUND TO THE INVENTION

WO2012015850 discloses a reflector and other arrangements for generating diffuse waves within a fluid space to clarify energy and heighten specific information in the space which carries a sound signal. In part there is a brief disclosure of a manifold. Some speaker drivers show a significant acceleration of the movement of the apparent acoustic centre at very high frequencies. The acoustic centre will start to move rapidly towards the voice coil of the driver above 10 kHz.

Some designs of the acoustic reflector embodiments disclosed in WO2012015650 are prone to acoustic centre geometric movements and had to be accommodated for such movements.

It is an object of this invention to provide improvements in the invention disclosed in WO2012015650.

### BRIEF DESCRIPTION OF THE INVENTION

The present invention provides an acoustical diffusion manifold transducer system which includes:

a surface having a plurality (N or N2), where N is an odd prime number) of acoustical channels arranged in an N×1 or N×N matrix; and

each acoustic channel driven by a loudspeaker driver and each channel length governed by the relationship

Ti.j=[(i2+j2) rem N]*unit delay.

Where T is delay between channels having sequential values in the number sequence and N is a prime number.

The channels are arranged to end in an outlet device so that sound waves from the speaker driver arrive in an ordered sequence. The outlet of each channel has the same area. The channels are pathways for sound waves generated by the loudspeaker driver and are preferably enclosed tubes of any suitable cross section.

Preferably the cross sectional area of each pathway is the same but the length of the pathway is determined by the algorithm for achieving diffusion.

Preferably the number sequence used in the acoustical diffusion manifold is selected, from a Quadratic Residue Sequence, a Barker code, an auto-correlation sequence or a complementary sequence.

Other suitable number sequences are those used in signal processing such as a Barker code, a zero auto- correlation sequence or a complementary sequence.

A Barker code is a sequence of N values of +1 and −1,

aⱼ for j=1, 2, . . . N

such that

$$\vert {\sum }_{j = 1}^{N - υ} {a}_{j} {a}_{j + υ} \vert \leq 1$$

for all 1≤v<N.

Autocorrelation is the cross-correlation of a signal with itself. Informally, it is the similarity between observations as a function of the time separation between them. It is a mathematical tool for finding repeating patterns, such as the presence of a periodic signal which has been buried under noise, or identifying the missing fundamental frequency in a signal implied by its harmonic frequencies. It is often used in signal processing for analyzing functions or series of values, such as time domain signals.

Complementary sequences (CS) derive from applied mathematics and are pairs of sequences with the useful property that their out-of-phase aperiodic autocorrelation coefficients sum to zero. Binary complementary sequences were first introduced by Marcel J. E. Golay in 1949. In 1961-1962 Golay gave several methods for constructing sequences of length 2^{N} and gave examples of complementary sequences of lengths 10 and 26. In 1974 R. J. Turyn gave a method for constructing sequences of length mn from sequences of lengths m and n which allows the construction of sequences of any length of the form 2^{N}10^{K}26^{M}.

### BRIEF DESCRIPTION OF THE DRAWINGS

FIG. 1 shows an isometric view of an acoustic manifold.

FIG. 2 is an isometric view of a loudspeaker driver and acoustical diffusion manifold.

FIG. 3 shows a plan and elevation view of the acoustical diffusion manifold described in FIG. 1.

FIG. 4 is a bottom view of the intake area of a hard on collider.

FIG. 5 Shows a plan identifying datum points soon a concentric splitter arranged hard on collider.

FIG. 8 shows a representative drawing of both the hard on collider portion of the manifold and the radiating outlet portion.

FIG. 7 shows an detailed isometric view of the ‘twister’ component.

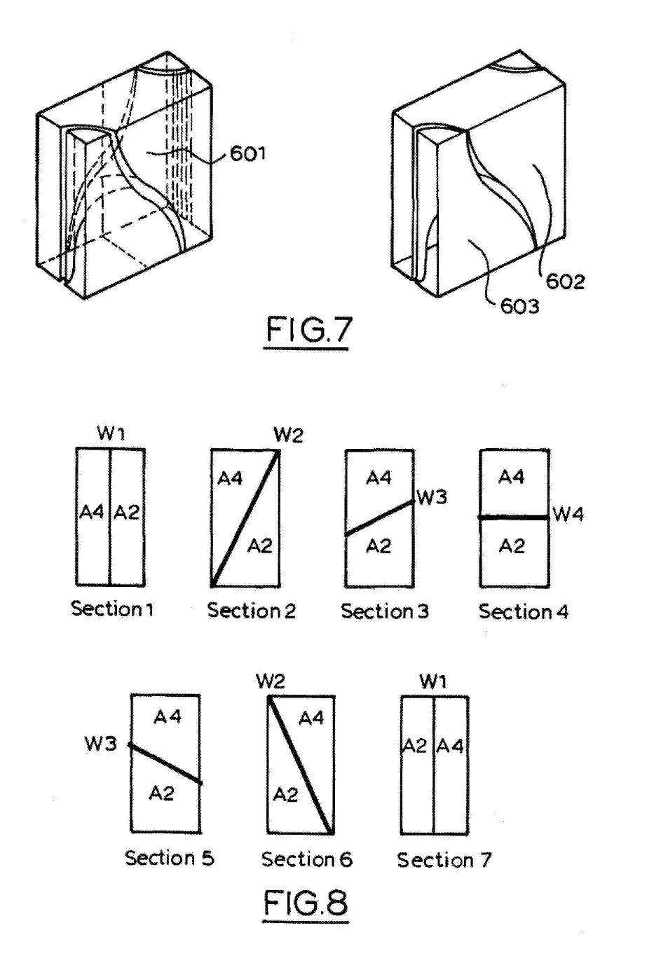

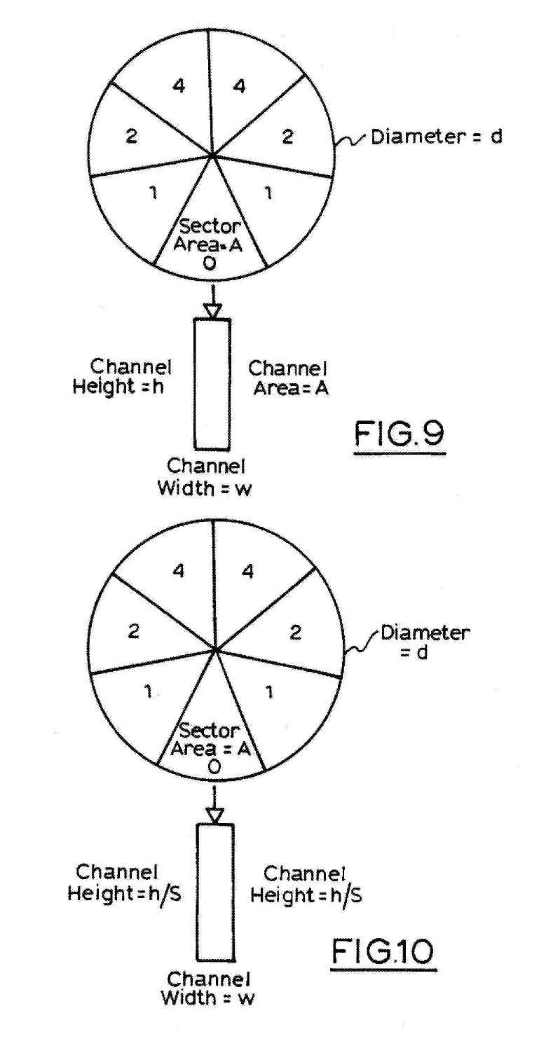

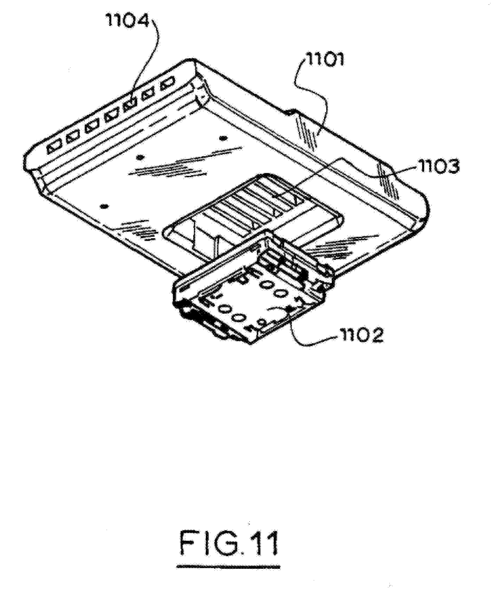

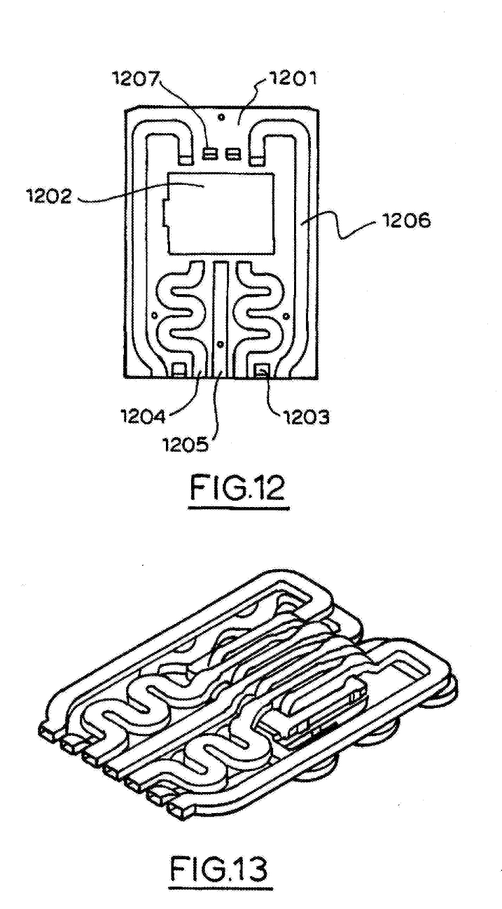

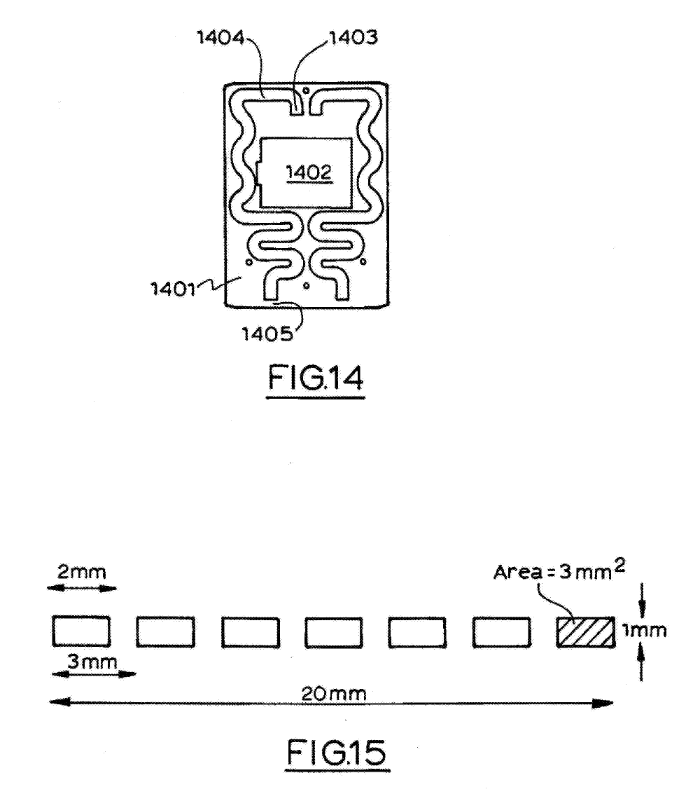

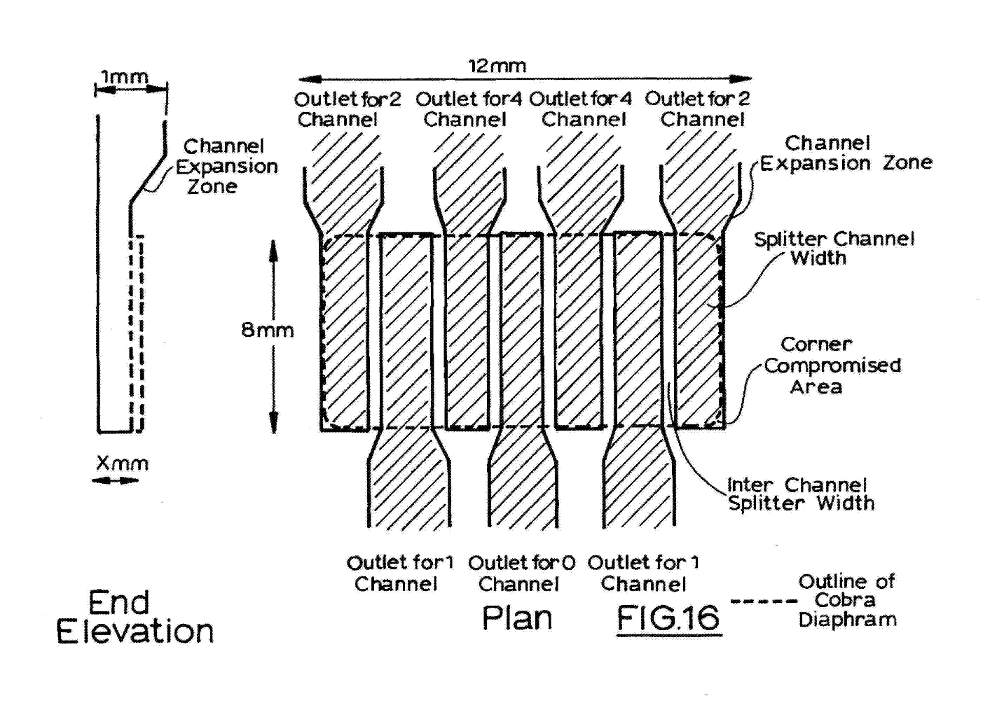

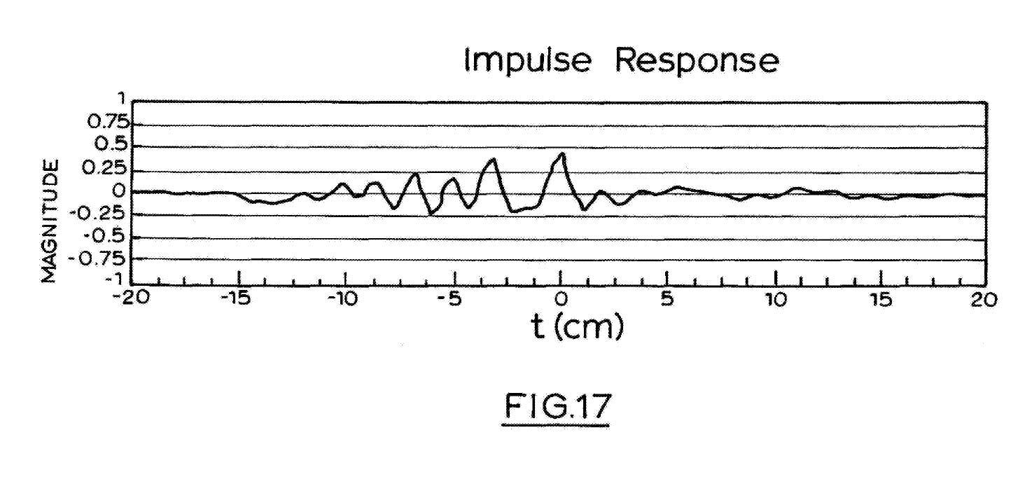

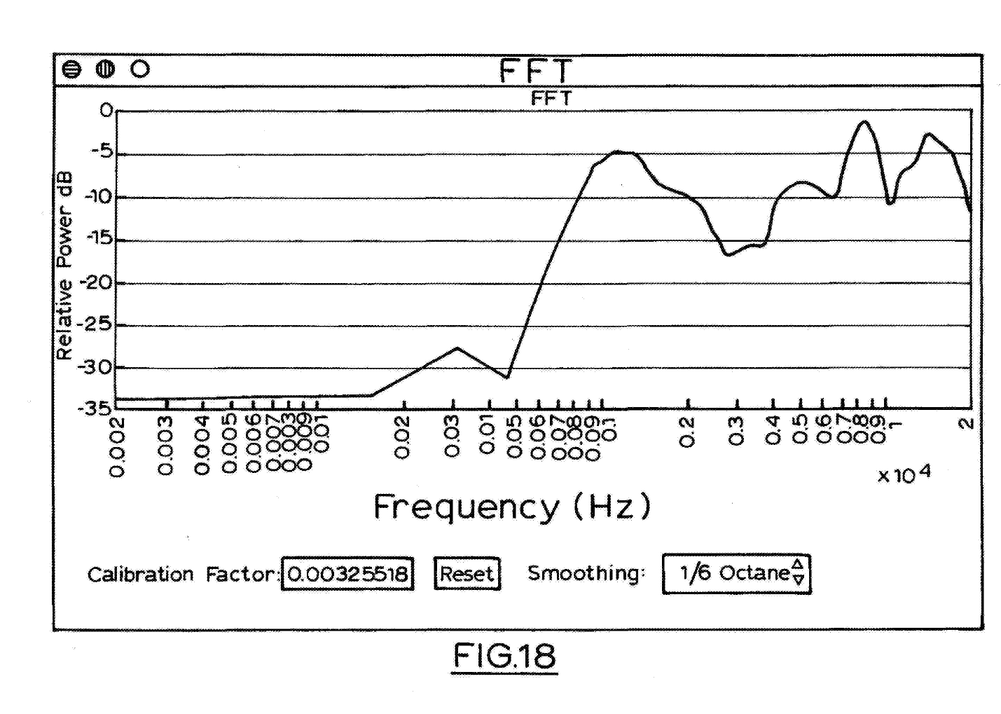

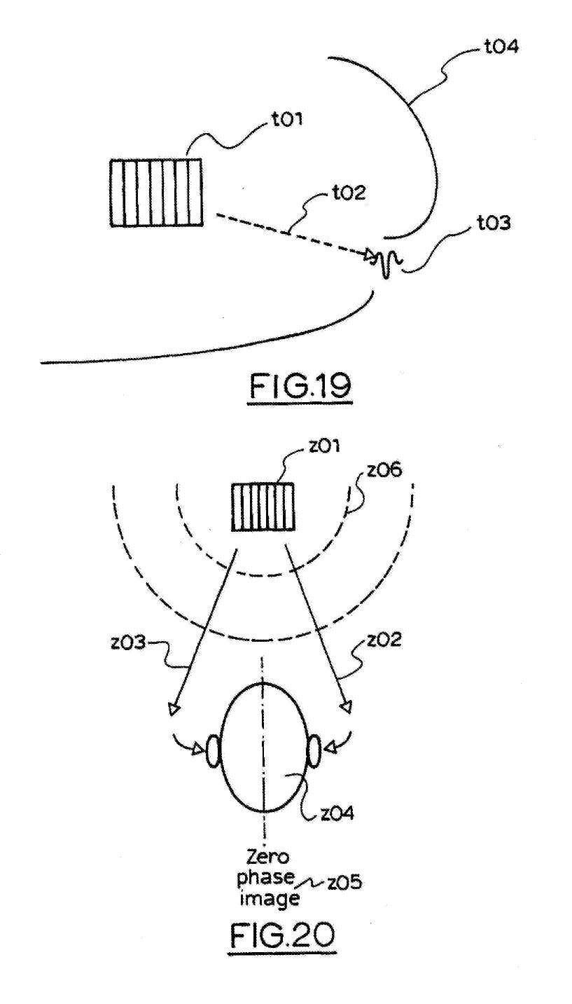

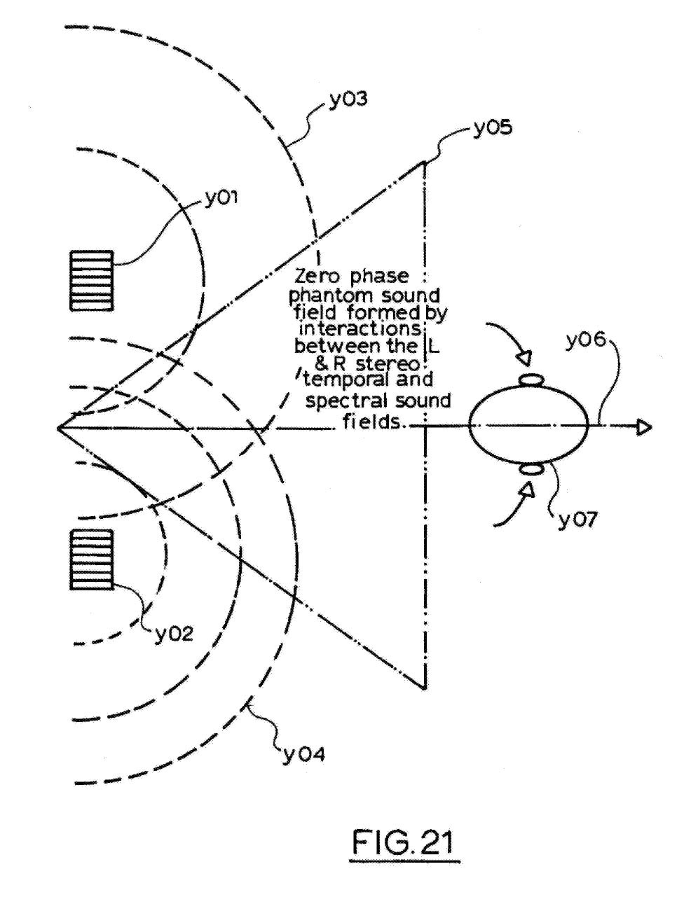

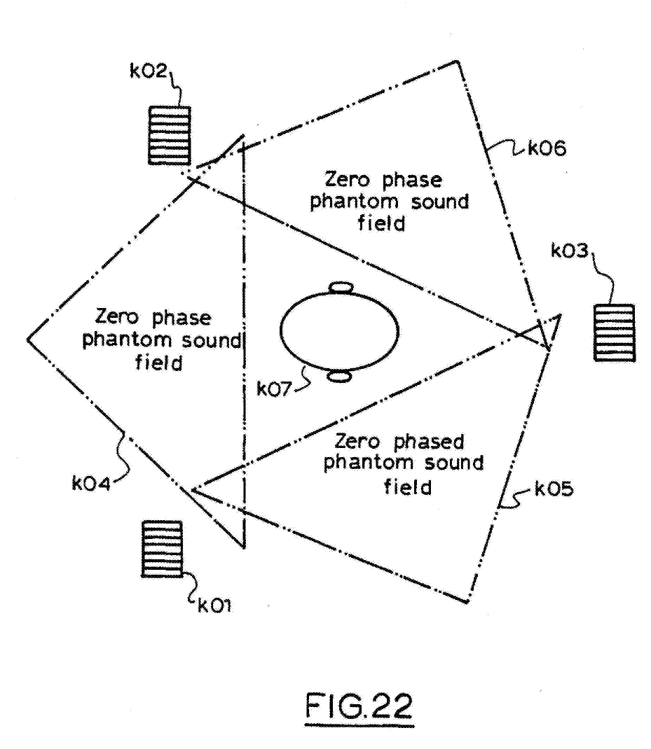

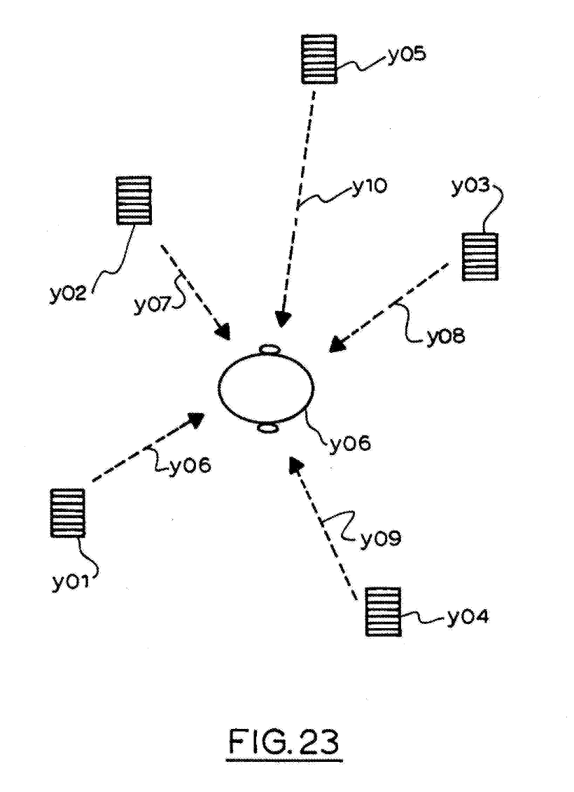

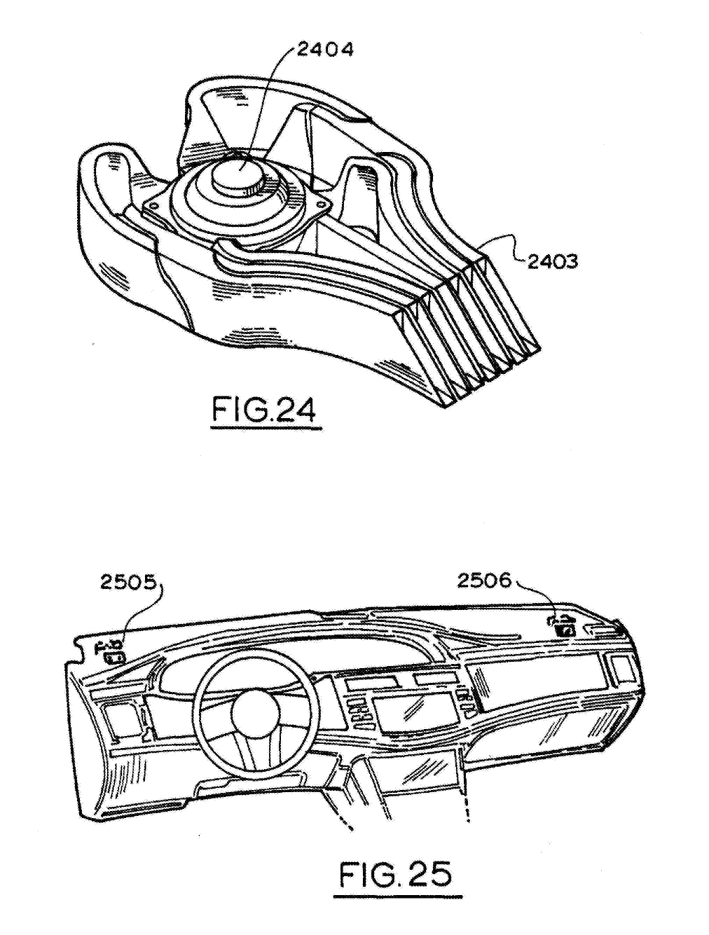

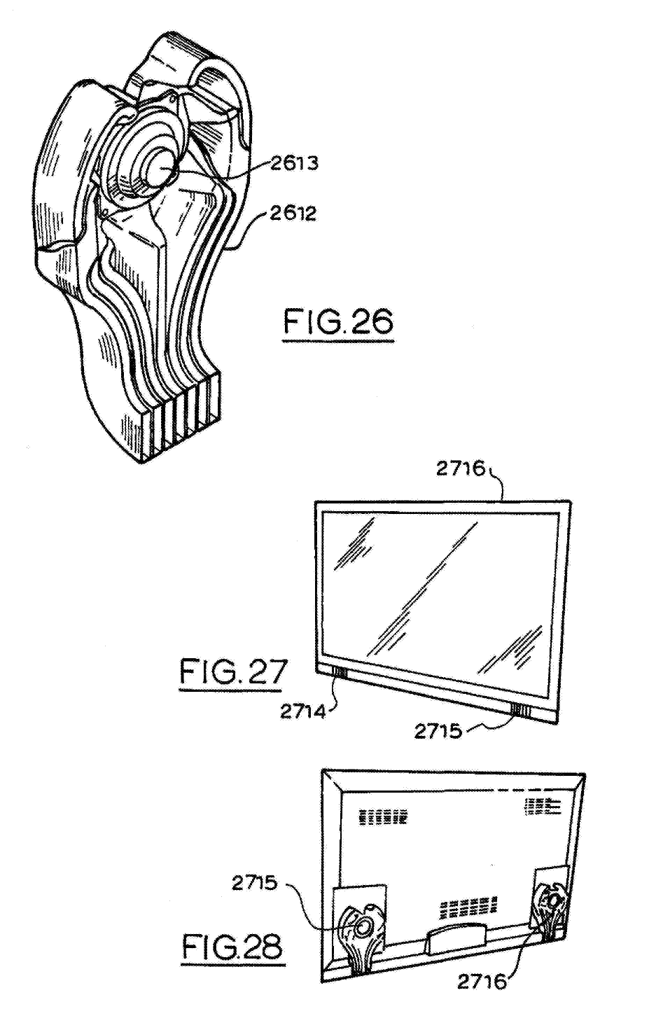

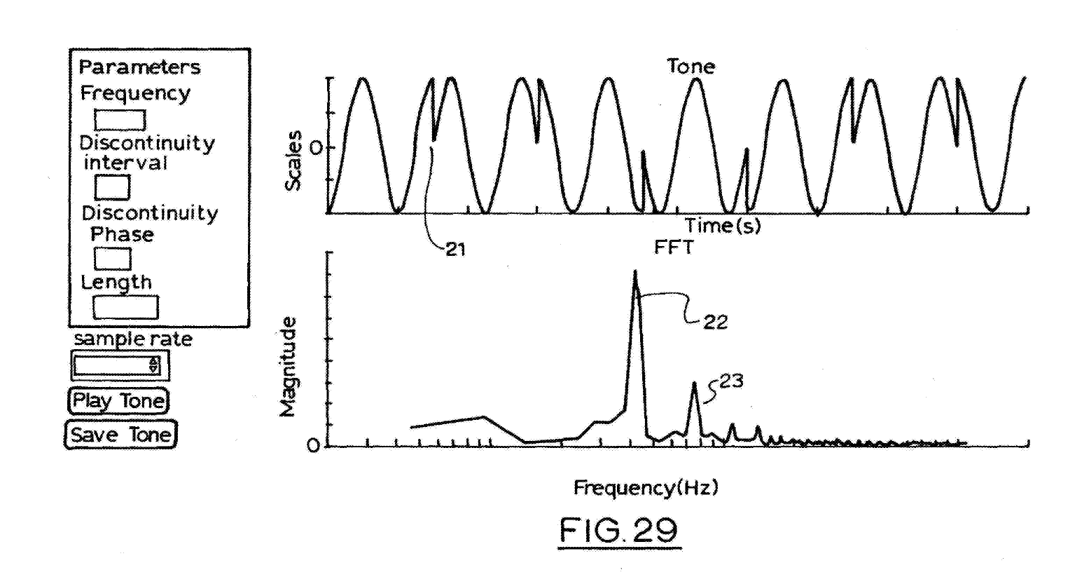

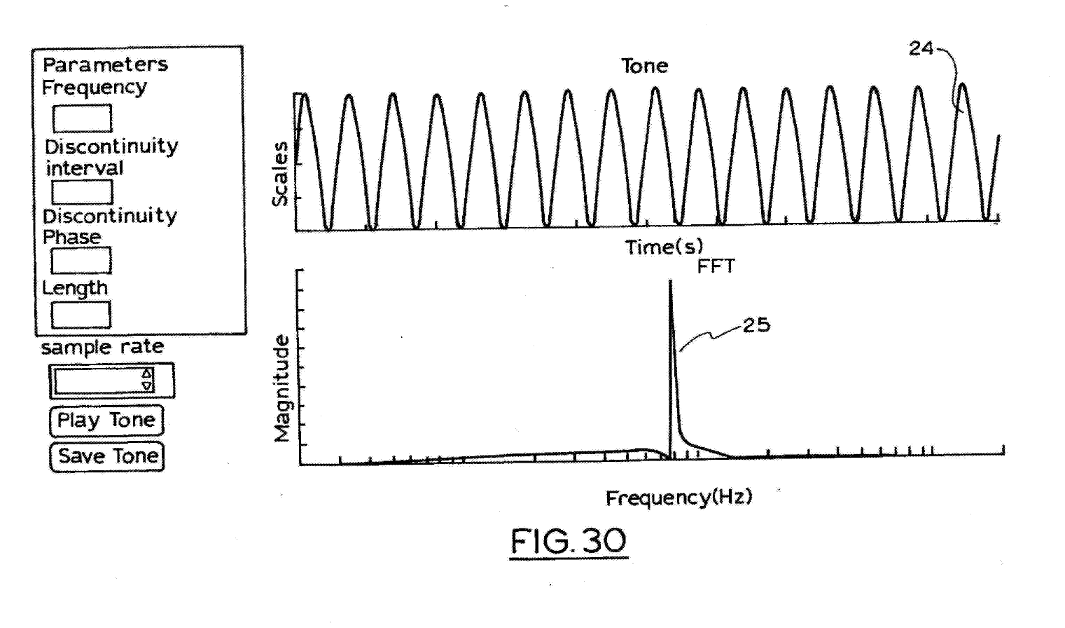

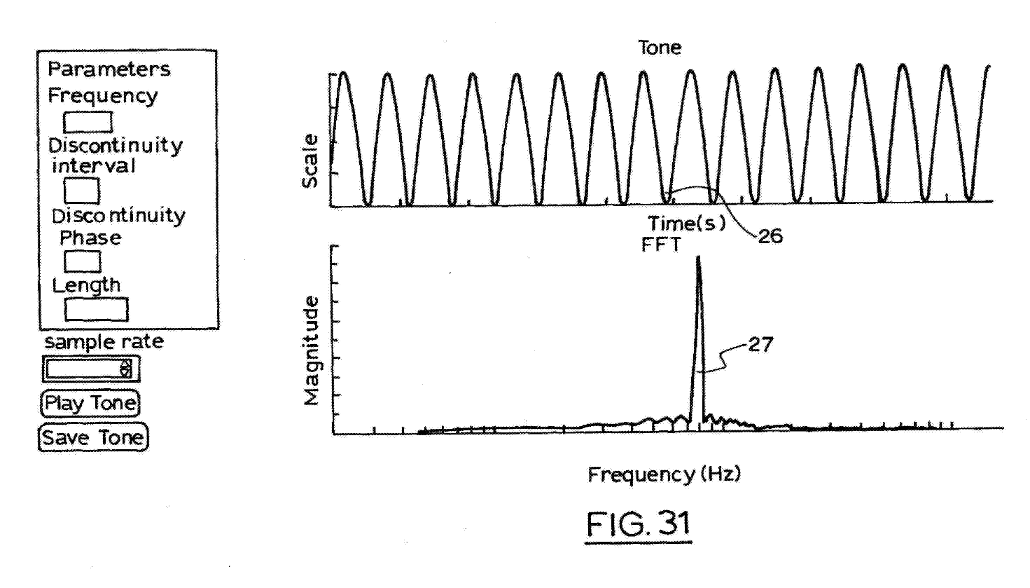

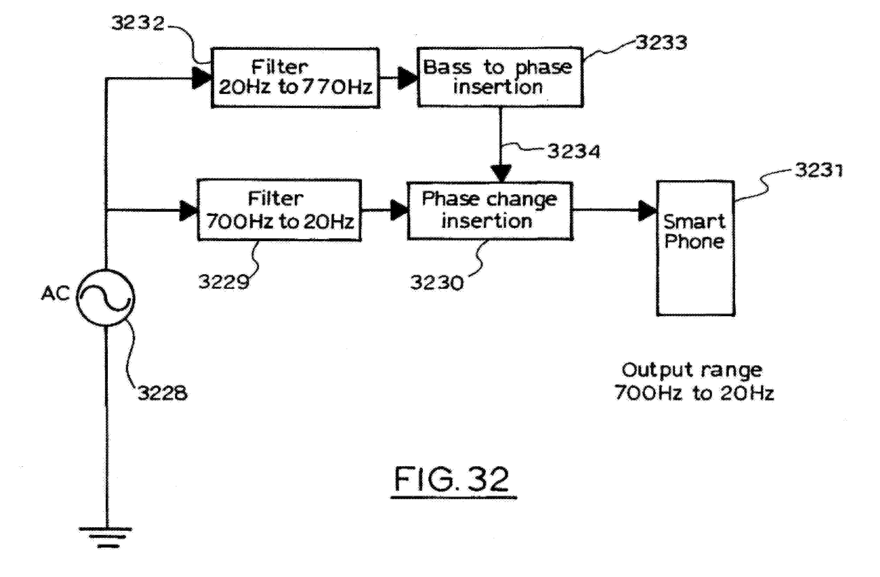

FIG. 8 shows sectional slices of portions of the twister element.

FIG. 9 shows an uncompressed channel design.

FIG. 10 shows a compressed channel design.

FIG. 11 is an isometric view of a miniature acoustical diffusion manifold.

FIG. 12 shows an isometric view of the skeleton of the miniature acoustical diffusion manifold.

FIG. 13 shows the top layer of sector element pathways for the miniature acoustic manifold.

FIG. 14 shows the lower layer 401 of the miniature acoustical diffusion manifold.

FIG. 15 shows the outlet dimensions of a cobra manifold.

FIG. 16 shows the hard on collider take off area details for a Cobra manifold;

FIG. 17 shows the close up detail of the captured impulse response of a loudspeaker of this invention;

FIG. 18 shows the Fast Fourier Transform FFT of a manifold of this invention;

FIG. 19 shows an isometric view of a manifold loudspeaker with a wavelet transient ring radiation;

FIG. 20 shows a listener in relation to a single manifold loudspeaker that radiates wavelet rings;

FIG. 21 shows a stereo air of manifold loudspeakers that radiate individually different wavelet ring patterns;

FIG. 22 shows a complete surround sound system using three manifold speakers;

FIG. 23 shows an extended virtual reality environment in which five manifold loudspeakers are used.

FIG. 24—is an isometric of a manifold speaker driver arrangement;

FIG. 25—is an isometric of a car dash containing two manifold speaker arrangements;

FIG. 26—is an isometric of a manifold speaker driver;

FIG. 27—is a front isometric view of a flat screen TV;

FIG. 28—is a rear isometric view of a flat screen TV;

FIG. 29—is a graphical view of a tone and its Fast Fourier Transform;

FIG. 30—is a graphical view of a tone and its Fast Fourier Transform;

FIG. 31—is a graphical view of a tone and its Fast Fourier Transform;

FIG. 32—is a schematic diagram of a system of sudden phase signal injection based on bass energy in the stop band of a loudspeaker.

### DETAILED DESCRIPTION OF PREFERRED EMBODIMENTS OF THE INVENTION

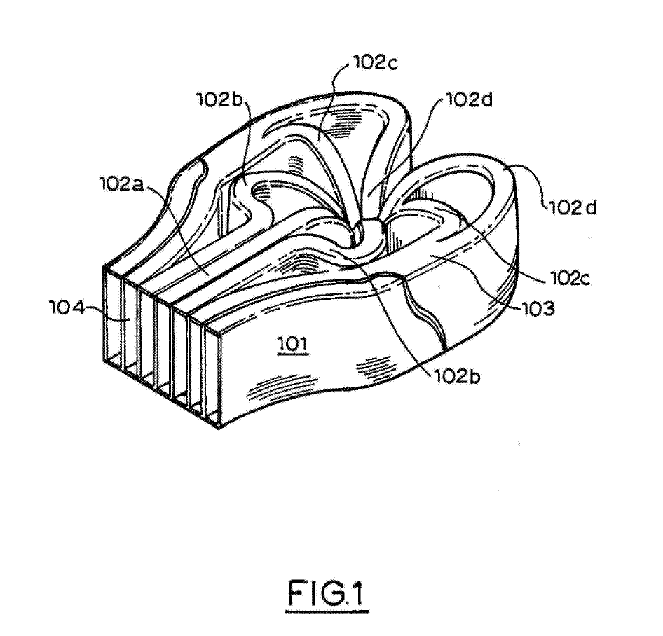

FIG. 1 shows an isometric view of an acoustical diffusion manifold 101 comprising 7 sectors 102 of which two sector pairs swap position through a twister portion 103 past each other so that all 7 sectors arrive at an outlet 104 in a sequential sequence from 0 to 6 (7 elements).

The length of each sector 102 is determined by the solutions of the quadratic residue sequence wherein a constant offset distance is added to the length of each sector such that a compromise of layout can accommodate both the sector distance variation requirement to satisfy the QRD design and the ergonomics of practical construction.

The solution to the QRD determines the relative length variation between sectors to be in the sequence 2, 4, 1, 0, 1, 4, and 2 at the outlet 104. The relative position within the natural 7 sectors of the hard on collider is 4, 2, 1, 0, 1, 2, and 4. It is therefore requisite that the outer elements representing the ‘2’ and ‘4’ elements swap past each other along the pathway from the hard on collider to the outlet.

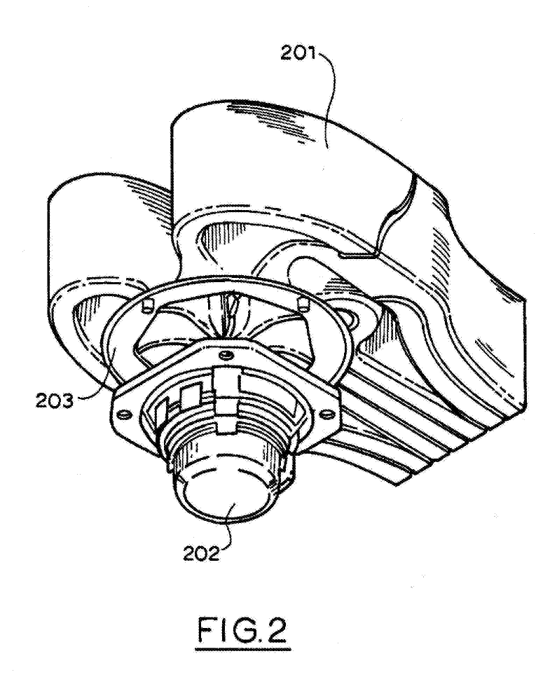

FIG. 2 is an isometric view of a loudspeaker driver and acoustical diffusion manifold showing the coupling positioning of the two components, Manifold 201 is coupled to driver 202 at the splitter intake 203 referred to as the ‘hard on collider.’ The role of the ‘hard on collider’ is to direct the acoustic wave generated by the piston motion of the loudspeaker driver into 7 (or N) equal but individual acoustic waves travelling along the sector channels. This should be achieved without causing distortion or reflections of acoustical energy. Therefore consideration should be given to maintaining the cross sectional area and general acoustical wave guide design methods in specifying this portion.

One such mathematical number sequence which can produce a diffuse wave response with auto-correlation equal to zero is known as a Quadratic Residue Sequence (QRS). The QRS is a number sequence with a total element length equal to any odd prime number N (e.g., 1, 3, 5, 7, 11, 13, 17, 19, 23, 29 . . . ); N is the number of sectors in the manifold. The individual element solutions are governed by the relationship

Sₙ=n² rem N (i.e. the least non negative remainder resulting when subtracting multiple N from n²)

Table 1 shows the solution to a QRS derived for a sequence having seven elements (i.e. N=7):

TABLE 1

| Element | Element No. | |
|---|---|---|
| Number | Squared | Sn |
| (O < n < (N − 1)) | (n2) | n2 rem N |
| 0 | 0 | O rem 7 = 0 |
| 1 | 1 | 1 rem 7 = 1 |
| 2 | 4 | 4 rem 7 = 4 |
| 3 | 9 | 9 rem 7 = 2 |
| 4 | 16 | 16 rem 7 = 2 |
| 5 | 25 | 25 rem 7 = 4 |
| 6 | 36 | 36 rem 7 = 1 |
| 7 | 49 | 49 rem 7 = 0 |
| 8 | 64 | 64 rem 7 = 1 |
| 9 | 81 | 81 rem 7 = 4 |
| 10 | 100 | 100 rem 7 = 2 |
| 11 | 121 | 121 rem 7 = 2 |
| 12 | 144 | 144 rem 7 = 4 |
| 13 | 169 | 169 rem 7 = 1 |

It is the property of the QRS that any one period (N adjacent elements) of the sequence can be used to achieve the diffuse wave function. Thus, the sequence can start at any number n, or fraction thereof, so long as it resolves one complete cycle of the sequence, i.e. Nw in periodic width (where w is the width of a well). The following Table 2 starts at n=4 and includes n=10, i.e. N=7 elements.

TABLE 2

| Element | Element No. | |
|---|---|---|
| Number | Squared | Sₙ |
| (O < n < (N − 1)) | (n²) | n² rem N |
| 4 | 16 | 2 |
| 5 | 25 | 4 |
| 6 | 36 | 1 |
| 7 | 49 | 0 |
| 8 | 64 | 1 |
| 9 | 81 | 4 |
| 10 | 100 | 2 |

The following Table 3 starts at n=2 and includes n=6, i.e. N=5 elements. The solution 4, 1, 0, 1, 4 happens to also appear nested inside the solution of 2, 4, 1, 0, 1, 4, 2 of table 2. It is a property of the QRS that solution for lower prime numbers appear nested inside higher prime number solutions.

TABLE 3

| Element | Element No. | |
|---|---|---|
| Number | Squared | Sₙ |
| (O < n < (N − 1)) | (n²) | n² rem N |
| 2 | 4 | 4 |
| 3 | 9 | 1 |
| 4 | 16 | 0 |
| 5 | 25 | 1 |
| 6 | 36 | 4 |

If a set of solutions Sₙ for any N, do not suit an application, a constant, can be added to each solution Sₙ, and then apply the formula: Sₙ=(Sₙ+a) rem N, where a is a constant.

Thus for the natural solution for N=7 being 0,1,4,2,24,1 we can add, e.g. a=3 to each Sₙ and transform the solution to 3,4,0,5,5,0,4.

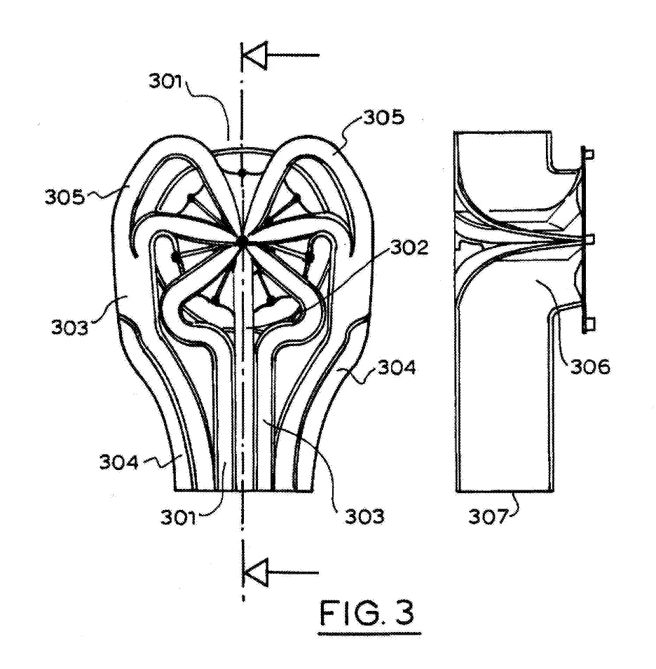

FIG. 3 shows a plan and elevation view of the acoustical diffusion manifold described in FIG. 1.

FIG. 3 Section AA shown in detail shows element detail 306 wherein the acoustic energy is converted from the piston motion of a moving coil loudspeaker to a lateral motion along the length of the sector element.

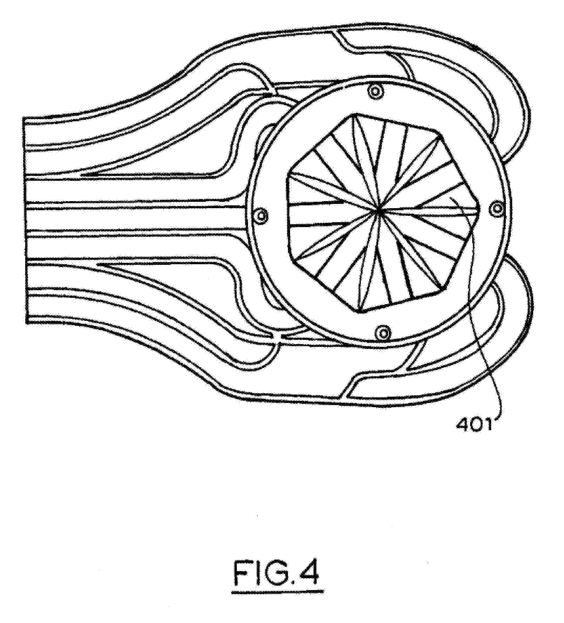

FIG. 4 is a bottom view of the concentric splitter intake area 401 of a hard on collider of the manifold described in FIGS. 1, 2, and 3.

In this view the detail of how the hard on collider portion, a circular area divided into 7 (N) equal sectors, segments the acoustic energy from a moving coil loudspeaker into 7 (N) equal area portions.

Each equal portion created by the hard on collider is then acoustically ducted 306 into the sector element pathway for individual guidance, through differing path lengths, and via the twister 303, to the outlet 307.

Some speaker drivers show a significant acceleration of the movement of the apparent acoustic centre at very high frequencies. The acoustic centre will start to move rapidly towards the voice coil of the driver as say above 10 kHz. The manifold design incorporating a concentric splitter arrangement to the hard on collider area 401 (FIG. 4). This arrangement eliminates errors due to movement in the acoustic centre as it is concentric to the loudspeaker driver and splits the acoustic driven wave arounds its centre into N identical portions. Thus any change in the acoustical centre position, as long as it is on a path concentric to the driver, will be symmetrically present in all N sectors.

Previous designs of the acoustic reflector embodiments by this inventor are prone to acoustic centre geometric movements and had to be accommodated for such movements.

The manifold 301 of FIG. 3 has a plurality of channels whose lengths difference are the solutions to the QRS multiplied by some unit depth, That is, the length of channel 0 (302) is 0* unit length plus a constant. I; the length of channel 1 (303), immediately adjacent to well 0 (302), is 1* unit depth plus a constant I; the length of channel 2 (304), immediately adjacent to well 1 (303), is 2* unit depth plus a constant I, etc. As the constant ‘I’ is present in the length of each channel it does not form part of the length difference between channels. It is desired that the elements of acoustic energy radiated from the source 302 (FIG. 2), when they are radiate from the outlet 307 having the channels 302, 303, 304, and 305 mix in a far field space to exhibit a diffuse and diffuse wave encoded sound field. The “perfect” solution to the QRS provides equal acoustic energy in all angular directions from the outlet 307 nominally within plus and minus PI/2 angular direction from the direction of radiation but in practice greater.

A preferred practical design of an acoustical diffusion manifold suitable for full range applications a channel outlet width is selected to be 8.15 mm. The overall reflector is therefore 57.05 mm.

The classic QRD solution for when the design frequency is selected to be 2600 Hz is shown in Table 4;

TABLE 4

| | | | | | | | Modified | |
|---|---|---|---|---|---|---|---|---|
| Ele- | Solution | | | Length | | | Sector | |
| ment | to QRD | Length | | doubling | | Constant I | Length | |
| 0 | 0 | 0 | mm | 0 | mm | 50 mm | 50 | mm |
| 1 | 1 | 9.5 | mm | 19 | mm | 50 mm | 69 | mm |
| 2 | 4 | 38.1 | mm | 76.2 | mm | 50 mm | 126.2 | mm |
| 3 | 2 | 19.1 | mm | 38.2 | mm | 50 mm | 88.2 | mm |
| 4 | 2 | 19.1 | mm | 38.2 | mm | 50 mm | 88.2 | mm |
| 5 | 4 | 38.1 | mm | 76.2 | mm | 50 mm | 126.2 | mm |
| 6 | 1 | 9.5 | mm | 19 | mm | 50 mm | 69 | mm |

The datum from which the sector channel lengths are measured may be any suitable point on the hard on collider area provided these datums are identical in acoustic timing (phase) and amplitude.

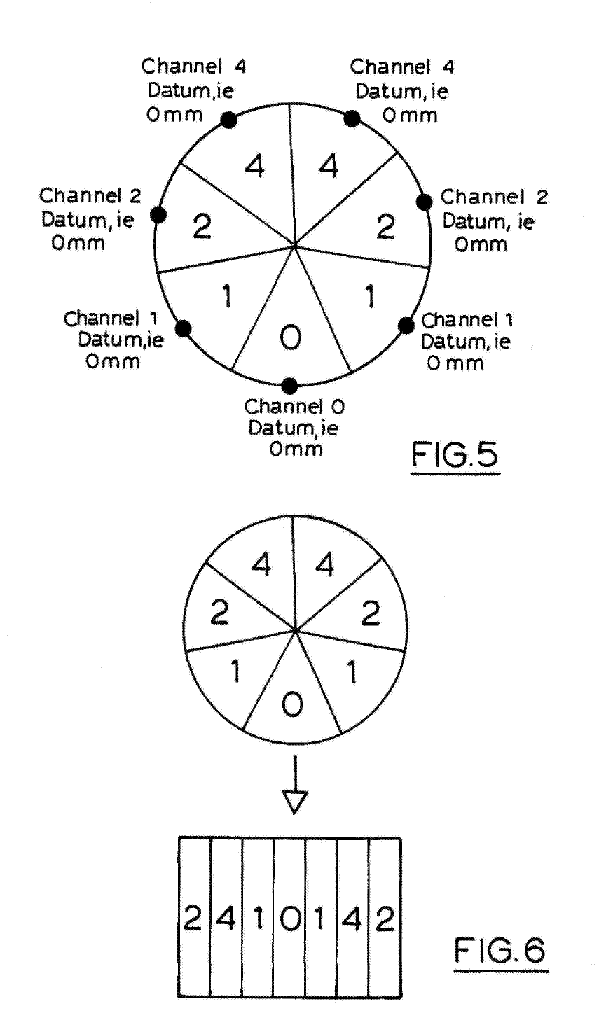

FIG. 5 shows the datum points defined as being on the perimeter of the concentric splitter cantered on each sector circumference. As this point is symmetrical to the sectors of the concentric splitter it can be assumed that the acoustic energy present at each point will be identical in time and therefore can be considered a zero datum to each relevant channel start point.

FIG. 6 shows a representative drawing of both a concentric splitter of the the hard on collider portion of the manifold and the radiating outlet portion. As the outlet is positioned to one side of the hard on collider there is a natural distribution of sector portions that suit the QRD elemental sequence position on the outlet.

The closest sector portion is given the ‘0’ element role and the path distance between it and the outlet is set to a minimum. Typically it would not be practical to set this distance to 0 mm. Therefore the resultant distance is considered a constant ‘I’ which is added to the length of all other element pathways so to add a set distance to all elements pathway. For example, using table 4 as a reference, the constant ‘I’ is set to be 50 mm. In practice this length ‘I’ could be meters in length. Such longer constant lengths would allow for the driver to be located somewhat remotely form the outlet. in such a way the drivers could be in the base of a flat screen TV whilst the radiating outlets where located at the edges of the screen. Similarly a car couldi ave the driver embedded centrally in the dash whilst the outlet was on the surface of the dash.

The hard on collider element adjacent to the ‘0’ sector are assigned the ‘1’ element pathway, The length of this pathway, using table 4 as a reference, is 69 mm being compromised of the constant ‘I’ of 50 mm and the ‘1’ element solution of 19 mm.

The path taken by the ‘1’ element is arranged such that it overall passage to the outlet translates to 69 mm in path length. Typically the centre line of the sector channel pathway is considered the reference for measuring length. Any resultant errors, due to whatever acoustical phenomena, can be corrected through micro adjustments to the element pathway passage to in effect increase or decrease the elemental length to compensate these errors.

The sectors immediately adjacent to the ‘1’ element are assigned the ‘2’ element pathway length. Using table 4 as a reference the 2′ element pathway length is 88.2 mm comprised of the constant ‘I’ of 50 mm and the ‘2’ element path length of 38.2 mm.

The path taken by the 2′ element is arranged such that it overall passage to the outlet translates to 88.2 mm in path length.

The sectors immediately adjacent to the the ‘2’ element are assigned the ‘4’ element pathway length. These two sectors also are adjacent to each other completing the seven sector elements of the hard on collider. Using table 4 as a reference the ‘4’ element pathway length is 126.2 mm comprised of the constant ‘I’ of 50 mm and the ‘4’ element path length of 76.2 mm.

The path taken by the ‘4’ element is arranged such that it overall passage to the outlet translates to 126.2 mm in path length. However the ‘2’ elements and the ‘4’ element have to traverse past each other to end up in the correct sequence in the outlet manifold.

FIG. 7 shows an detailed isometric view of the ‘twister’ component of the portion of sector elements ‘2’ and ‘4’ wherein they change position such that the outside element of path length determined by ‘4’ 602 exchanges position with the inside element of path length determined by ‘2’ 603 via the constant cross sectional area transform portion 601. In this view the element 602 on the outside of the sector element formation is manipulated by twister such that element end up being transformed to the inside location by the time it reaches the outlet.

FIG. 8 shows seven sections through a twister portion including the start and end points. At the start the separating fin is vertical and the area of the ‘4’ element (A4) is equal to the area of the ‘2’ element (A2). At the next section the central separating fin has started to rotate about its central point. As its length is longer than the initial separator its width will be slightly less. In such a way the exact cross sectional area of A4 and A2 can be maintained.

In the next section the separator fin has traversed past the vertical limits and hots the side walls. Its length is shorter thus its width is wider such that the cross sectional areas A4 and A2 are maintained. This process continues for the remaining sections. This a constant cross sectional area is maintained for the channels and the channel 2 as the acoustical energy transverses the twister portion.

Two main design variables, the unit depth and the element width govern the useful frequency bandwidth over which the acoustical diffusion manifold is effective. The lowest useful frequency is controlled by the amount of path introduced by the various well depths. The highest useful frequency is controlled by the width of the wells. For frequencies higher than that of which the related wavelength is equivalent to 2×the channel width the acoustic energy will not travel on a direct path along the length of the channels. It will travel on diagonal paths along the length of the channels and thus the effective length will be greater than the physical lengths. This will cause the diffusion process to move out of tolerance.

To control the low frequency design frequency of the mechanical diffuse wave generator, the unit length is set to equal 1/N times the design wavelength. For example, if the unit length is 19 millimeters and N=7, then the design wavelength is given by:

X=N×19 millimeters=133 millimeter

From this, the design frequency is calculated:

$$\begin{matrix}F = c / {λ}_{D} \\ = 343 / ( 133 \times {10}^{- 3} ) \\ = 2.6 kHz\end{matrix}$$

Below the design frequency the wells become dimensionally insignificant to the phase of the source frequency and the acoustical arrangement acts as a normal radiator or flat surface reflector. The highest frequency at which the reflector is, effective, the cut-off frequency, is governed by the individual well width, w, or the relation to the design frequency. Using the previous example, if the well width is 9.5 millimetres then the cut-off frequency is given by;

$$\begin{matrix}λ = w \times 2 \\ = 19 millimeters\end{matrix}$$

And thus the frequency is given by:

$$\begin{matrix}F = c / {λ}_{W} \\ = 343 / ( 19 \times {10}^{- 3} ) \\ = 18.05 kHz\end{matrix}$$

Another factor that limits the high frequency effectiveness is that the sequence does not work at a frequency of (N-1) times the design frequency. That is, still using the numbers of the previous example,

$$\begin{matrix}{λ}_{high} = {λ}_{D} / ( N - 1 ) \\ {λ}_{D} = 133 mm \\ thus {λ}_{high} = 133 mm / 6 \\ = 22.2 mm \\ thus {f}_{high} = 343 / {λ}_{D} \\ = 343 / 22.2 mm \\ = 15.5 kHz\end{matrix}$$

In this example, cut-off frequency governed by the design frequency is less the lesser of the two limiting frequencies and is thus the actual high frequency cut off point. Therefore, the lower of the two frequencies will be the cut-off frequency. i.e. 15.5 kHz.

To ensure against error interference with the zero auto-correlation property of the diffuse wave function great care and correct compensations have to be incorporated into the design. At zero autocorrelation the output by itself will carry no meaningful information that can be interpreted by an observant receptor such as that of the human listening system. The resultant diffuse wave function is ‘silent’. However, the tolerance to errors is very small whereby the percentage error from ideal should be less than 3% in amplitude or phase. The greater the error the more audible the diffuse wave function becomes. It is the intensity of the driving source signal we want to hear in the listening spatial environment, not the diffuse wave function. Because the QRS effects a wide range of frequencies nominally it is most important that the higher end of the useful spectrum of the design maintain a criteria of less than 3% error. As the frequency spectrum lowers, the component wavelength increases and the errors due to path travel will become relatively insignificant provided the source spatial origin remains stationary over the spectral domain.

In a preferred embodiment the cross sectional area of the hard on collider is the same as the total outlet area. Effort is taken to ensure the cross-sectional area of the individual acoustic ducts is constant from the source to the outlet.

FIG. 9 shows an uncompressed cross sectional area configuration whereby the area of the concentric splitter sector is the same as the channels path cross sectional area.

EG—If the concentric splitter diameter is 50 mm them the area of the concentric splitter is given by;

$$\begin{matrix}{Area}_{CS} = Pl \times 25 {mm}^{2} \\ = 1963 {mm}^{2}\end{matrix}$$

The area of one sector is;

$$\begin{matrix}{Area}_{Sector} = 1963 {mm}^{2} / 7 \\ = 280 {mm}^{2}\end{matrix}$$

If the width of the channel is 9.5 mm then the height of the channel is given by;

$$\begin{matrix}Height = {Area}_{Sector} / Width \\ = 280 / 9.5 \\ = 29.5 mm\end{matrix}$$

In another embodiment the portion of the acoustical diffusion manifold that forms the hard on collider (305 or FIG. 3) is used to compress the cross-sectional area of the sector outlet of the hard on collider take off portion to a scale of the original take off area and therefore amplifying the volume velocity of the acoustic waves within the acoustical ducts. This will increase the sound pressure level inside the ducts. Care should be taken to ensure the acoustical wave does not introduce unwanted distortions using this compression of area technique.

FIG. 10 shows an compressed cross sectional area configuration whereby the area of the concentric splitter sector is larger than the channels path cross sectional area.

EG—If the concentric splitter diameter is 50 mm them the area of the concentric splitter is given by;

$$\begin{matrix}{Area}_{CS} = Pl \times 25 {mm}^{2} \\ = 1963 {mm}^{2}\end{matrix}$$

The area of one sector is;

$$\begin{matrix}{Area}_{Sector} = 1963 {mm}^{2} / 7 \\ = 280 {mm}^{2}\end{matrix}$$

If the width of the channel is 9.5 mm then the height of the channel is given by;

$$\begin{matrix}Height = {Area}_{Sector} / ( Width \times Scale ) \\ = 280 / ( 9.5 \times 2 ) \\ = 14.8 mm\end{matrix}$$

By introducing a scale factor of 2 we have halved the height of the outlet.

As a consequence we can expect the volume velocity of the acoustic energy inside the channels to be twice that of the previous uncompressed arrangement.

The benefit of such an approach is that the size of the outlet manifold can be reduced and therefore compacting the resultant design.

FIGS. 11 to 16 illustrate a minituarised manifold suitable for use in a cell phone of the smart phone type.

FIG. 11 is an isometric view of a miniature acoustical diffusion manifold 1101 designed to accommodate a Cobra smartphone loudspeaker 1102 via the recess 1103 wherein it is divided into 7 equal portions by a hard on collider and guided by length variable pathways determined by the QRD towards the outlet array 1104.

The loudspeaker driver is considered to behave as a perfect piston over its applications range of frequencies. If this is not the case then a concentric splitter hard on collider take off arrangement could be used.

If it does not suit to have the loudspeaker driver coupled directly to the hard on collider area then a small cavity of air can be used to compliantly couple these elements. The compliance space effect of absorbing low frequencies are arranged to occur below the effective radiation active portion of the smartphone loudspeaker driver. For a Cobra loudspeaker the active region of radiation is usually 500 Hz and above. Thus the compliant cavity should become an acoustical short circuit at 500 Hz and above.

FIG. 8 shows an isometric view of the skeleton of the miniature acoustical diffusion manifold 701 without is casing. The various pathways for the 7 (N) elements via which they find their way to the outlet 704 are displayed. The objective is to compact the design as much as possible without loosing the desired acoustical effects provided by convolving an audio signal with a QRD.

TABLE 5

| Ele- | Solution | | | Length | | | Modified | |
|---|---|---|---|---|---|---|---|---|
| ment | to QRD | Length | | doubling | | Constant I | Length | |
| 0 | 0 | 0 | mm | 0 | mm | 16 mm | 16 | mm |
| 1 | 1 | 9.5 | mm | 15.5 | mm | 16 mm | 31.5 | mm |
| 2 | 4 | 38.1 | mm | 62 | mm | 16 mm | 78 | mm |
| 3 | 2 | 19.1 | mm | 31 | mm | 16 mm | 47 | mm |
| 4 | 2 | 19.1 | mm | 31 | mm | 16 mm | 47 | mm |
| 5 | 4 | 38.1 | mm | 62 | mm | 16 mm | 78 | mm |
| 6 | 1 | 9.5 | mm | 15.5 | mm | 16 mm | 31.5 | mm |

To control the low frequency design frequency of the miniature acoustical diffusion manifold, the unit length is set to equal 1/N times the design wavelength. For example, if the unit length is 15.5 millimetres and N=7, then the design wavelength is given by:

X=N×15.5 millimeters=108.6 millimeter

From this, the design frequency is calculated:

$$\begin{matrix}F = c / {λ}_{D} \\ = 343 / ( 108.6 \times {10}^{- 3} ) \\ = 3.16 kHz\end{matrix}$$

Below the design frequency the wells become dimensionallyinsignificant to the phase of the source frequency and the acoustical arrangement acts as a normal radiator or flat surface driver. The highest frequency at which the reflector is effective, the cut-off frequency, is governed by the individual well width, w, or the relation to the design frequency. Using the previous example, if the well width is 3.0 millimetres then the cut-off frequency is given by;

$$\begin{matrix}λ = w \times 2 \\ = 6.0 millimeters\end{matrix}$$

And thus the frequency is given by:

$$\begin{matrix}F = c / {λ}_{W} \\ = 343 / ( 6.0 \times {10}^{- 3} ) \\ = 57.2 kHz\end{matrix}$$

Another factor that limits the high frequency effectiveness is that the sequence does not work at a frequency of (N-1) times the design frequency. That is, still using the numbers of the previous example,

$$\begin{matrix}{λ}_{high} = {λ}_{D} / ( N - 1 ) \\ {λ}_{D} = 108.6 mm \\ thus {λ}_{high} = 108.6 mm / 6 \\ = 18.0 mm \\ thus {f}_{high} = 343 / {λ}_{D} \\ = 343 / 18.0 mm \\ = 19 kHz\end{matrix}$$

In this example, cut-off frequency governed by design frequency is less the lesser of the two limiting frequencies and is thus the actual high frequency cut off point. Therefore, the lower of the two frequencies will be the cut-off frequency. i.e. 19 kHz.

FIG. 12 shows the top layer of sector element pathways for the miniature smartphone acoustical diffusion manifold. In this layer 1201 is a rebate 1202 adequate, suitable, and effective to accommodate a Cobra srnartphone loudspeaker.

Using table 5 as a reference the centre element 1205 is given the path length 16 mm.

Adjacent to the centre element 1205 but on the opposite side are the intakes to element ‘4’ 1207. These element are diverted to the lower layer via ducts 1207 and reappear adjacent the array outlet at locations 1203. These ‘4’ pathways are manipulated in length such that they are 78 mm long.

On the same side as the centre ‘0’ element 1205 but to either side is the ‘1’ element 1204 that is 31.5 mm long in pathway length.

FIG. 10 shows the lower layer 1301 of the miniature acoustic manifold, This layer also is adequate, effective, and suitable to accommodate a Cobra smartphone loudspeaker via a recess 1302 that is the same location that of the upper layer 901. The upper layer 1201 feeds via the duct 1207 and 1303 acoustic energy into the pathway 1304 towards the outlet and ducts it up to the outlet layer via ducts 1305. FIG. 15 shows the outlet dimensions of a typical smart phone manifold design. The channel outlet is 2 mm wide and 1 mm high. The cross sectional area is therefore 2 mm². There are seven channels spaced 3 mm apart. This makes the output array 20 mm wide and 1 mm high. The total area of the outlet is 7×2 mm²=14 mm².

FIG. 16 shows the take-off area of the cobra diaphragm.

As the diaphragm of the cobra has radiuses corners care has to be taken to compensate for this in the ‘2’ element take off areas. As the area above the diaphragm is so small it is not possible to have normal sized channels areas in the take off hard on collider area. Thus a compression scale is used.

The diaphragm is 12 mm long and 8 mm high. Thus it has a cross sectional area of 12×8=96 mm²

As the outlet is 14 mm² a scale of 96/14=6.9 compression factor is implicit in this design. Thus the volume velocities are 6.9 times higher in the channels than at the diaphragm. One needs to be careful not to enter into non linear acoustic sound pressure levels within the channels when implementing these high scale factors.

FIG. 17 shows the close up detail of the captured impulse response of a loudspeaker of this invention. This is the window of sound from −20 cm prior to the maximum recorded value to 20 cm after the maximum recorded value. The central section around t=0 cm is shaped like that of a Gabor wavelet. But there is a lot of the signal present in the measurement before and after the Gabor wavelet looking middle portion. This may be the ‘ringing’ from a poorly damped spectral enclosure.

FIG. 18 shows the Fast Fourier Transform FFT of a manifold of this invention developed for a Cobra manifold. This embodiment is suitable for use on small consumer electronics devices such as smart phones. So it has the ability to temporally mark (wavelet encode) into the listening space the sudden phase changes in the audio signal. The prior art criteria of FFT show little distortion through the addition of this wavelet encoding manifold. This spectral curve can be equalised by the host smart phone electronics.

There is little spectral bass below 500 z in this device. It is plausible to convert bass sounds into their equivalent sudden phase jumps on a carrier frequency above 500 Hz such that these bass sounds become perceptible via the temporal information channel to the brain rather than the spectral information channel to the brain that will require FFT energy below 500 Hz. Spectral energy below 500 Hz is simply not supported by the physics of these small speaker drivers.

A benefit of the increased sound pressure levels due to increased volume velocities is an increased radiated sound pressure level into the listening space.

FIG. 19 shows a manifold loudspeaker t01 radiating a sound field in which there is a phase anomaly (temporal activity) at a radius t02. The transient of this phase nominally is a wavelet t03 and this wavelet exists of a circular ring 104 at radius t02 around the manifold loudspeaker t01.

FIG. 20 shows the same manifold loudspeaker z01 radiating two phase anomalies causing two temporal wavelet rings z06. A human standing in this radiated field will hear these temporal rings z06 via both ears z03 and z02 such to cause a zero phase image z05 inside ones perception system.

FIG. 21 shows a stereo air of manifold loudspeakers y01 and y02 that radiate temporal rings y03 and y04 based on each channels phase anomalies. Monaural information in the stereo mix will manifest as coherent acoustic energy along the centre line of these speakers y06. A listener y07 will hear both direct energy form manifold speakers y01 and y02. They will also experience a zero phase phantom sound field formed by interactions between he left and right stereo signals causing both a spectral and temporal sound field. Phase congruency will exists in this zero phase sound field. Minute difference between left and right channels will build a virtual reality acoustic within the zero phase sound field.

This image will exhibit depth of field as well as specular imaging between channels. FIG. 22 shows three manifold loudspeakers k01, k02, and k03 placed around a listener k07. These three manifold loudspeakers 101 k02 and k03 will create three direct sound field form this monaural content and three phantom zero phase sound fields form the interactive sound fields. This will provide a laterally immersive listening space.

FIG. 23 shows a complete virtual reality sound space created with five manifold loudspeaker y01 y02 y03 y04 and y05. Manifold speakers y01 y02 y03 and y04 are in a quadraphonic arrange placed laterally around the listener y06. Manifold speaker y05 is places above the listener y06. these manifold loudspeakers y01 y02 y03 y04 and y05 will create five direct zero phase monaural perceptions form monaural content form each source. They will create 6 lateral stereo zero phase sound fields form the interactions of lateral sound sources. i.e.;

| | |
|---|---|
| y01 and y02 | y02 and y03 |
| y03 and y04 | y04 and y01 |
| y01 and y03 | y02 and y04 |

and they will create four overhead zero phase sound fields from the stereo interaction between;

| | |
|---|---|
| y01 and y05 | y02 and y05 |
| y03 and y05 | y04 and y05 |

This will provide an immersive reality acoustic through the recording and manipulation of a 5 channel audio signal. Encoding 5 channels of audio in a digital file is known in the art. A zero phase zone such as described is a simulation of a ‘live’ acoustic sound field.

6 lateral stereo zero phase soundfields

4 vertical zero phase soundfields

5 direct mono zero phase soundfields

FIG. 24 shows manifold 2403 with the speaker driver 2404 mounted hard against its hard on collider. The profile of the dual arrangement is that both parts nest inside each other. The outlet is shaped as to suit the arrangement into the dash of a car.

FIG. 25 shows the manifold speaker arrangement of FIG. 24 mounted inside the dash board of a car 2405 and 2506. This the only visual impact to the driver is the outlet array of the manifolds. This is a classic stereo arrangement.

FIG. 26 shows manifold 2612 with the speaker driver 2613 mounted hard against its hard on collider. The profile of the dual arrangement is that both parts nest inside each other. The outlet is shaped as to suit the arrangement onto the back of a flat screen TV.

FIG. 27 shows an isometric view of a flat screen TV 2716 with such an arrangement of FIG. 26 mounted into it. The outlets 2714 and 2715 are on the front surface of the TV 2716. FIG. 28 shows the rear isometric view of the flat screen. TV 2716 where manifolds 2714 and 2715 are visible. As manifolds 2714 and 2715 are made of plastic they may be injection moulded at the same time as the complete rear cover of the TV is moulded. This substantially reduces product costs.

FIG. 29 shows a constructed ‘tone’ consisting of a 500 Hz carrier. However at every 3 milliseconds a sudden 90 degree phase change occurs 21. The Fast Fourier transform shows that spectrally this is seen as a combination of approximately 410 Hz and 750 Hz components. However in this tone the 333 Hz being the 3 millines interval is dominant.

FIG. 30 shows a constructed lone consisting of a 800 Hz carrier 24. The Fast Fourier transform shows that spectrally this is seen as 800 Hz only 25.

FIG. 31 shows a constructed lone consisting of a 800 Hz carrier and a small phase change (15 degrees) at 10 millisecond intervals 26. The Fast Fourier transform shows that spectrally this is still seen as 800 Hz only. however audibly the tone of 100 Hz can be heard due to the 10 millisecond phase changes. Smart phones are known to have little energy below 500 Hz to 700 Hz. The physical speaker driver cannot support tones below this region.

FIG. 32 shows a system to insert bass into the pass band of a smart phone (700 Hz and above) by first splitting the audio signal into below(3232 and above(3229) 700 Hz components. The higher pass region 3229 is fed to the smartphone speaker 3231 after it passes through a phase modifier 3230, The lower portion of the audio signal 3231 is passed through a filter that extracts bass information and converts it into phase change on the pass band 3229 signal. In this method bass is encoded as phase change into the above 700 Hz audio signal and becomes perceptible as bass through the human temporal perception systems.

Similarly other loudspeaker drivers suitable to other consumer electronic and industrial applications dimensions and power output can have an acoustical diffusion manifold designed which when coupled to that driver increase the resultant clarity, coverage, and imagery of the listening experience.

Other suitable number sequences are those used in signal processing such as a Barker code, a zero auto-correlation sequence or a complementary sequence

The invention has been described with reference to specific embodiments. It will be apparent to those skilled in the art that various modifications may be made and other embodiments can be used without departing from the broader scope of the invention. For example, alternative forms of zero autocorrelation sequences or methods of achieving relative sequence element time delays may be used in the present invention. Therefore, these and other variations upon the specific embodiments are covered by the present invention.

1. An acoustical diffusion manifold transducer system which includes:
an acoustic loudspeaker driver coupled to the manifold
the manifold inlet having a plurality N(where N is an odd prime number) of inlets to acoustical pathways in communication with the acoustical driver, a manifold outlet which comprises a surface having a plurality (N where N is an odd prime number) of outlets for the acoustical pathways arranged in an N×1 or N×N matrix;
the cross sectional area of each pathway is the same and
each pathway length is governed by the relationship
where T is delay between pathways having sequential values in the number sequence and N is an odd prime number.

2. An acoustical manifold transducer as claimed in claim 1 in which the inlets of the acoustical pathways are arranged radially about the acoustical driver to form a hard on collider.

3. An acoustical manifold transducer as claimed in claim 2 in which the cross sectional area of the hard on collider is about the same as the total area of the outlets.

4. An acoustical manifold transducer as claimed in claim 1 in which N is 7.

5. An acoustical manifold transducer as claimed in claim 2 in which the outlets of the acoustical pathways are oriented at an angle greater than a right angle from the hard on collider.

6. An acoustical manifold transducer system as claimed in claim 5 fitted into a cell phone, vehicle dashboard or television screen support.

7. An acoustical manifold transducer as claimed in claim 2 in which N is 7.

8. An acoustical manifold transducer as claimed in claim 3 in which N is 7.

9. An acoustical manifold transducer as claimed in claim 7 in which the outlets of the acoustical pathways are oriented at an angle greater than a right angle from the hard on collider.

10. An acoustical manifold transducer system as claimed in claim 9 fitted into a cell phone, vehicle dashboard or television screen support.

11. An acoustical manifold transducer as claimed in claim 8 in which the outlets of the acoustical pathways are oriented at an angle greater than a right angle from the hard on collider.

12. An acoustical manifold transducer system as claimed in claim 11 fitted into a cell phone, vehicle dashboard or television screen support.
